(19) United States
(12) Patent Application Publication
(10) Pub. No.: US 2016/0309709 A1
(43) Pub. Date: Oct. 27, 2016

(54) BIOCIDAL LAYER WITH PARTICLES

(71) Applicant: Eastman Kodak Company, Rochester, NY (US)

(72) Inventors: Ronald Steven Cok, Rochester, NY (US); Mitchell Stewart Burberry, Webster, NY (US)

(21) Appl. No.: 14/695,086

(22) Filed: Apr. 24, 2015

(51) Int. Cl. A01N 25/10; B32B 37/26; B32B 43/00; A01N 59/16

(52) U.S. Cl. CPC A01N 25/10; A01N 59/16; B32B 37/26; B32B 43/006; B32B 2037/268; B32B 2307/70; B32B 2391/00; B32B 2398/00

(57) ABSTRACT

A biocidal article includes a support having a first side and an opposing second side. A polymer layer including a polymer is adhered to the first side of the support; the polymer layer has an average layer thickness and a top surface. A plurality of biocidal particles are fixed within the polymer layer, the biocidal particles are coated by the polymer, the biocidal particles have a median particle diameter less than or equal to two microns, and the biocidal particles include a metal salt having soluble constituents. The average layer thickness is less than or equal to two times the median particle diameter, at least some of the biocidal particles extend beyond the average layer thickness from the support, and the polymer forms a semi-permeable membrane through which the soluble constituents percolate to the top surface.

### FIELD OF THE INVENTION

The present invention relates to an antibacterial article having a thin polymer layer including biocidal particles.

### BACKGROUND OF THE INVENTION

Widespread attention has been focused in recent years on the consequences of bacterial and fungal contamination contracted by contact with common surfaces and objects. Some noteworthy examples include the sometimes-fatal outcome from food poisoning due to the presence of particular strains of Escherichia coli in undercooked beef; Salmonella contamination in undercooked and unwashed poultry food products; as well as illnesses and skin irritations due to Staphylococcus aureus and other micro-organisms. Anthrax is an acute infectious disease caused by the spore-forming bacterium bacillus anthracis. Allergic reactions to molds and yeasts are a major concern to many consumers and insurance companies alike. In addition, significant fear has arisen concerning the development of antibiotic-resistant strains of bacteria, such as methicillin-resistant Staphylococcus aureus (MRSA) and vancomycin-resistant Enterococcus (VRE). The U.S. Centers for Disease Control and Prevention estimates that 10% of patients contract additional diseases during their hospital stay and that the total deaths resulting from these nosocomially-contracted illnesses exceeds those suffered from vehicular traffic accidents and homicides.

In response to these concerns, manufacturers have begun incorporating antimicrobial agents into materials used to produce objects for commercial, institutional, residential, and personal use. Noble metal ions such as silver and gold ions are known for their antimicrobial properties and have been used in medical care for many years to prevent and treat infection. In recent years, this technology has been applied to consumer products to prevent the transmission of infectious disease and to kill harmful bacteria such as Staphylococcus aureus and Salmonella.

In common practice, noble metals, metal ions, metal salts, or compounds containing metal ions having antimicrobial properties can be applied to surfaces to impart an antimicrobial property to the surface. If, or when, the surface is inoculated with harmful microbes, the antimicrobial metal ions or metal complexes, if present in effective concentrations, will slow or even prevent altogether the growth of those microbes. Recently, silver sulfate, Ag₂SO₄, described in U.S. Pat. No. 7,579,396, U.S. Patent Application Publication 2008/0242794, U.S. Patent Application Publication 2009/0291147, U.S. Patent Application Publication 2010/0093851, and U.S. Patent Application Publication 2010/0160486 has been shown to provide efficacious antimicrobial protection in polymer composites. The United States Environmental Protection Agency (EPA) evaluated silver sulfate as a biocide and registered its use as part of EPA Reg. No, 59441-8 EPA EST. NO. 59441-NY-001. In granting that registration, the EPA determined that silver sulfate was safe and effective in providing antibacterial and antifungal protection. Antimicrobial activity is not limited to noble metals but is also observed in other metals such as copper and organic materials such as triclosan, and some polymeric materials.

It is important that the antimicrobial active element, molecule, or compound be present on the surface of the article at a concentration sufficient to inhibit microbial growth. This concentration, for a particular antimicrobial agent and bacterium, is often referred to as the minimum inhibitory concentration (MIC). It is also important that the antimicrobial agent be present on the surface of the article at a concentration significantly below that which can be harmful to the user of the article. This prevents harmful side effects of the article and decreases the risk to the user, while providing the benefit of reducing microbial contamination. There is a problem in that the rate of release of antimicrobial ions from antimicrobial films can be too facile, such that the antimicrobial article can quickly be depleted of antimicrobial active materials and become inert or non-functional. Depletion results from rapid diffusion of the active materials into the biological environment with which they are in contact, for example, water soluble biocides exposed to aqueous or humid environments. It is desirable that the rate of release of the antimicrobial ions or molecules be controlled such that the concentration of antimicrobials remains above the MIC. The concentration should remain there over the duration of use of the antimicrobial article. The desired rate of exchange of the antimicrobial can depend upon a number of factors including the identity of the antimicrobial metal ion, the specific microbe to be targeted, and the intended use and duration of use of the antimicrobial article.

Antimicrobial coatings are known in the prior art, for example as described in U.S. Patent Application Publication 2010/0034900. This disclosure teaches a method of coating a substrate with biocide particles dispersed into a coating so that the particles are in contact with the environment. In other designs, for example as taught in U.S. Pat. No. 7,820,284, a polymeric overcoat is applied over a base coat including anti-microbial particles. The overcoat is permeable or semi-permeable to the agents released from the anti-microbial particles. The polymer overcoat is dissolvable in a solvent that does not dissolve the polymeric base coat. U.S. Pat. No. 6,905,698 discloses a particulate carrier material impregnated with a biocidal formulation that can serve as a surface coating in order to control the release of the biocide. Non-planar coatings are also known to provide surface topographies for non-toxic bio-adhesion control, for example as disclosed in U.S. Pat. No. 7,143,709. U.S. Pat. No. 8,124,169 teaches an anti-microbial coating system. U.S. Patent Application Publication 2009/0304760 describes a biocidal film-forming composition and method for coating surfaces and U.S. Patent Application Publication 2012/0171272 describes a composition and method for a biocidal dispersion with sub-micronized particles.

Fabrics or materials incorporating biocidal elements are known in the art and commercially available. U.S. Pat. No. 5,662,991 describes a biocidal fabric with a pattern of biocidal beads. U.S. Pat. No. 5,980,620 discloses a means of inhibiting bacterial growth on a coated substrate comprising a substantially dry powder coating containing a biocide. U.S. Pat. No. 6,437,021 teaches a water-insoluble polymeric support containing a biocide. Methods for depositing thin silver-comprising films on non-conducting substrates are taught in U.S. Patent Application Publication 2014/0170298.

### SUMMARY OF THE INVENTION

There is an ongoing need for biocidal coatings that are useful in reducing the quantity of undesirable bacteria on a surface. The present invention provides a polymer layer that is inhospitable to bacteria over a period of time, can be readily replaced with little effort, and that can be cleaned.

In accordance with various embodiments of the present invention, a biocidal article comprises:

a support having a first side and an opposing second side;

a polymer layer including a polymer adhered to the +++first side of the support, the polymer layer having an average layer thickness and a top surface;

a plurality of biocidal particles fixed within the polymer layer, the biocidal particles coated by the polymer, the biocidal particles having a median particle diameter less than or equal to two microns, and the biocidal particles including a metal salt having soluble constituents; and

wherein the average layer thickness is less than or equal to two times the median particle diameter, at least some of the biocidal particles extend beyond the average layer thickness from the support, and the polymer forms a semi-permeable membrane through which the soluble constituents percolate to the top surface.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1 is a cross section illustrating an embodiment of the present invention;

FIG. 2 is a cross section illustrating another embodiment of the present invention;

FIGS. 3-6 are flowcharts illustrating various methods of making and using the present invention;

FIGS. 7A-7C are sequential cross sections illustrating steps in a method of making embodiments of the present invention;

FIGS. 8A-8B are sequential cross sections illustrating additional steps in a method of making embodiments of the present invention;

FIG. 9 is a cross section illustrating another embodiment of the present invention; and

FIG. 10 is a cross section illustrating another embodiment of the present invention.

The Figures are not drawn to scale since the variation in size of various elements in the Figures is too great to permit depiction to scale.

### DETAILED DESCRIPTION OF THE INVENTION

The present invention provides a layer on a support that is inhospitable to bacteria over a period of time, can be readily replaced with little effort, and that can be cleaned. The coating support can be applied to a variety of surfaces for which it is useful to reduce the bacterial load on the surface. In useful applications of the present invention, the surfaces include those found in medical environments, including hospitals, medical clinics, and medical offices. In various embodiments, the surfaces can be structural (e.g. floors, walls, ceilings, doors) or can be a part of medical devices, medical tools, or implements found in medical environments. In other embodiments, the surfaces can be found in home, commercial, or industrial environments or applications.

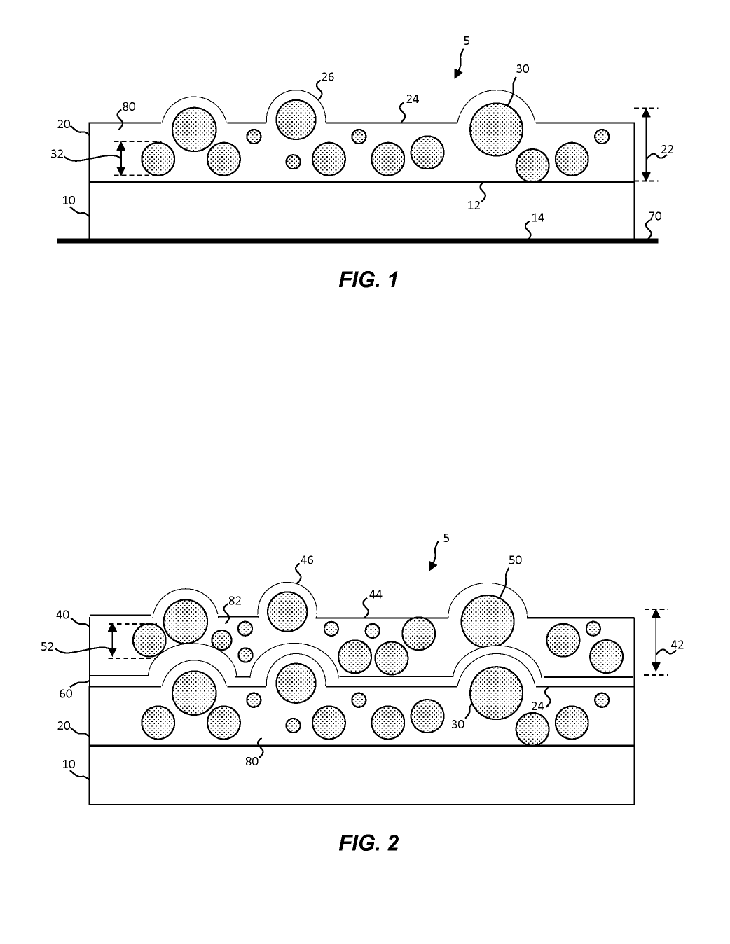

Referring to FIG. 1, in an embodiment of the present invention, a biocidal article 5 includes a support 10 having a first side 12 and an opposing second side 14. A polymer layer 20 including a polymer 80 is adhered to the first side 12 of the support 10. The polymer layer 20 has an average layer thickness 22 and a top surface 24. A plurality of biocidal particles 30 are fixed within the polymer layer 20. The biocidal particles 30 are coated by the polymer 80 to form a coating 26 and can have a distribution of sizes. The biocidal particles 30 have a median particle diameter 32 less than or equal to two microns and the biocidal particles 30 include a metal salt having soluble constituents. The average layer thickness 22 is less than or equal to two times the median particle diameter 32. At least some of the biocidal particles 30 extend beyond the average layer thickness 22 from the support 10, and the polymer 80 forms a semi-permeable membrane through which the soluble constituents percolate to the top surface 24.

The polymer layer 20 covers the support 10 in two dimensions, for example in a coating. The average layer thickness 22 is the average of the thickness of the layer from the support 10 or a layer formed on the support 10 in two dimensions over the support, for example with a two-dimensional sampling of points over the layer that provides statistical confidence in the average thickness.

In various embodiments of the present invention, the metal salt is a silver salt, silver sulfate, a copper salt, or a copper sulfate or includes silver nitrate, silver chloride, silver bromide, silver iodide, silver iodate, silver bromate, silver tungstate, or silver phosphate or any combination thereof. In an embodiment, the metal salt concentration in the polymer layer 20 is greater than or equal to 0.0007 and less than or equal to 15 weight %, 10 weight %, or 5 weight %. In another embodiment the metal salt concentration in the polymer layer 20 is greater than or equal 0.001 and less than or equal to 1 weight %. In a useful embodiment, the metal salt is water soluble.

According to the present invention, the polymer layer 20 including biocidal particles 30 resists the growth of undesirable biological organisms, including microbes, bacteria, or fungi or more generally, eukaryotes, prokaryotes, or viruses. In particular, the polymer layer 20 inhibits the growth, reproduction, or life of infectious micro-organisms that cause illness or death in humans or animals and especially antibiotic-resistant strains of bacteria.

The polymer layer 20 is rendered biocidal by including biocidal particles 30 such as ionic metals or metal salts in the polymer layer 20. In an embodiment, some of the biocidal particles 30 in the polymer layer 20 are exposed to the environment and can interact with any environmental contaminants or biological organisms in the environment. Although exposed (rather than coated) biocidal particles are likely to be efficacious in destroying microbes, in some embodiments the biocidal efficacy of such exposed biocidal particles is greatly reduced by cleaning or exposure to moisture. In various embodiments, the biocidal particles 30 are silver or copper, are a metal sulfate, have a silver component, are a salt, have a sulfur component, have a copper component, are a silver sulfate salt, or include phosphors.

In one embodiment, the polymer layer 20 includes a surfactant. In other embodiments, the polymer 80 is a cured resin, for example a cross-linked resin, the polymer 80 is transparent, the polymer 80 is colored, or the polymer 80 includes homopolymers and copolymers. The homopolymers and copolymers can include polyesters, styrenes, monoolefins, vinyl esters, α-methylene aliphatic monocarboxcylic acid esters, vinyl ethers, or vinyl ketones. Alternatively, the polymer 80 can interact with the biocidal particles 30 to color the polymer layer 20. The polymer 80 can include one or more of a polyurethane resin, epoxy resin, silicone resin, polyamide resin, modified rosin, paraffins or waxes, carboxymethyl cellulose (CMC), gelatin, alkali-treated gelatin, acid treated gelatin, gelatin derivatives, proteins, protein derivatives, synthetic polymeric binders, water soluble microgels, polystyrene sulphonate, poly(2-acrylamido-2-methylpropanesulfonate), polyphosphates, polyesters of aromatic or aliphatic dicarboxcylic acids with one or more aliphatic diols.

As shown in FIG. 1, the biocidal article 5 can further include a surface 70 adhered to the second side 14 of the support 10.

As shown in FIG. 2, the biocidal article 5 includes the support 10 with the polymer layer 20 and further includes a removable polymer layer 40 that includes other polymer 82 removably adhered to the polymer layer 20 or to another layer adhered to the polymer layer 20, for example a release layer 60. The removable polymer layer 40 has another average layer thickness 42 and other top surface 44. A plurality of other biocidal particles 50 are fixed within the removable polymer layer 40. The other biocidal particles 50 are coated by the other polymer 82 with other coating 46. The other biocidal particles 50 have another median particle diameter 52 less than or equal to two microns and the other biocidal particles 50 include a metal salt having other soluble constituents. The other average layer thickness 42 of the removable polymer layer 40 is less than or equal to two times the other median particle diameter 52. At least some of the other biocidal particles 50 extend beyond the other average layer thickness 42 from the first polymer layer 20. The other polymer 82 forms a semi-permeable membrane through which the other soluble constituents percolate to the other top surface 44.

In a useful embodiment, the polymer 80 and the other polymer 82 are the same polymer 80 or type of polymer. In another embodiment, the polymer 80 and the other polymer 82 are not the same type of polymer. Likewise, in a useful embodiment, the biocidal particles 30 and the other biocidal particles 50 are the same type of biocidal particles. In another embodiment, the biocidal particles 30 and the other biocidal particles 50 are not the same type of biocidal particles. Further, in an embodiment the average layer thickness 22 and the other average layer thickness 42 are the same and the median particle diameter 32 and the other median particle diameter 52 are the same. In other embodiments, the average layer thicknesses 22, 42 and the median particle diameters 32, 52 are different.

In a further useful embodiment, and as illustrated in FIG. 2, a release layer 60 is located between the polymer layer 20 and the removable polymer layer 40. In an embodiment, the release layer 60 is an adhesive lightly adhering the polymer layer 20 and the removable polymer layer 40 together but that can release the polymer layer 20 from the removable polymer layer 40 if the removable polymer layer 40 is mechanically separated from the polymer layer 20, for example by manual peeling. A variety of release layers and adhesives are known.

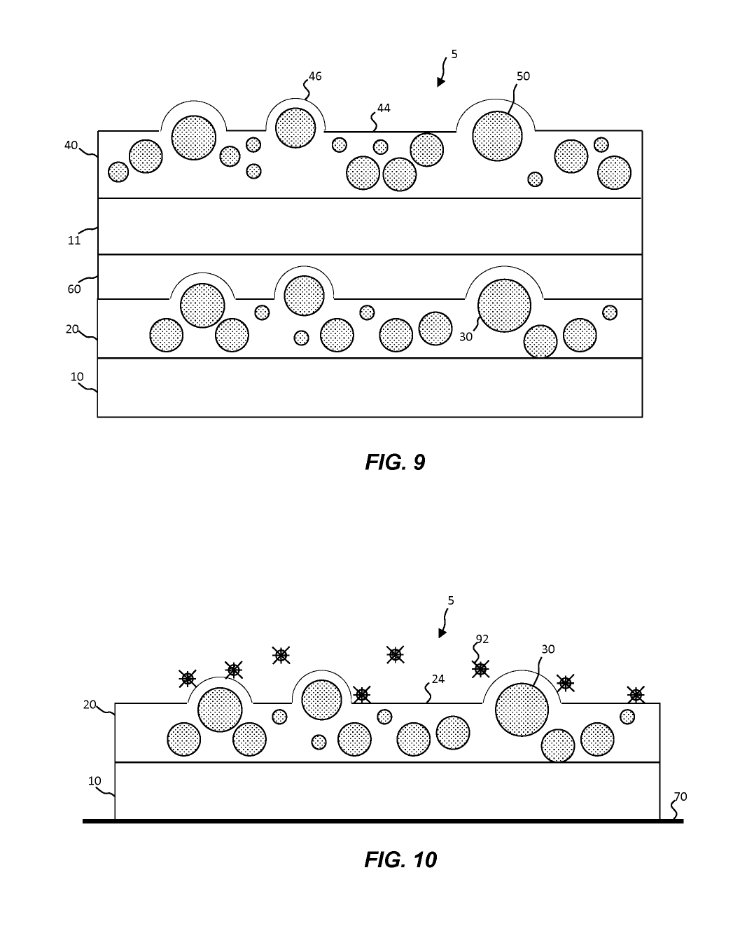

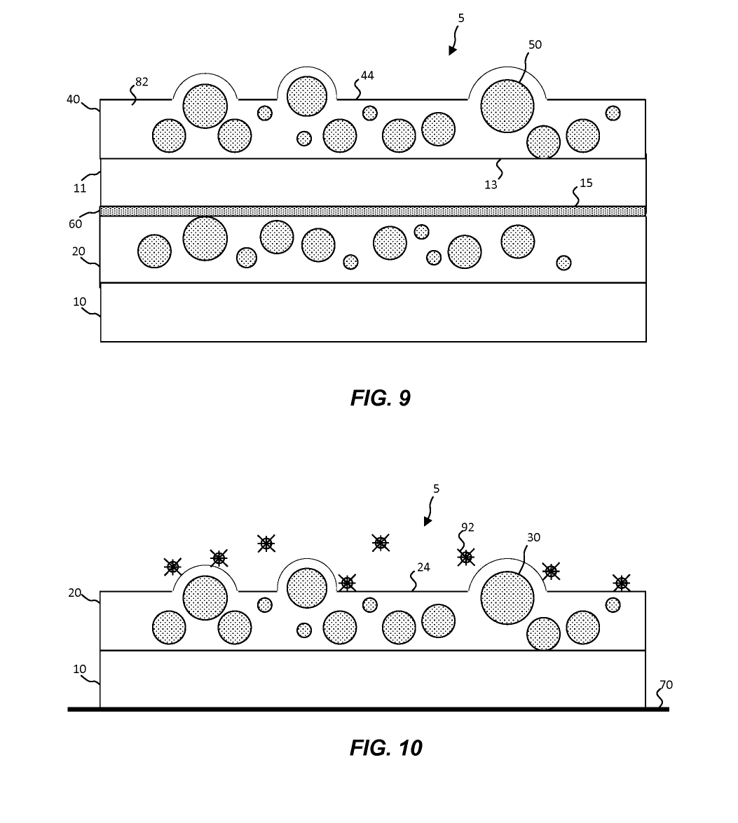

In a further useful embodiment, and as illustrated in FIG. 9, the removable polymer layer 40 has a separate other support 11 with another first side 13 and an opposed other second side 15. The other second side 15 is laminated to the polymer layer 20 or to the optional release layer 60 (as shown). The removable polymer layer 40 is adjacent to the other first side 13 so that the other support 11 is located between the polymer layer 20 (on support 10) and the removable polymer layer 40.

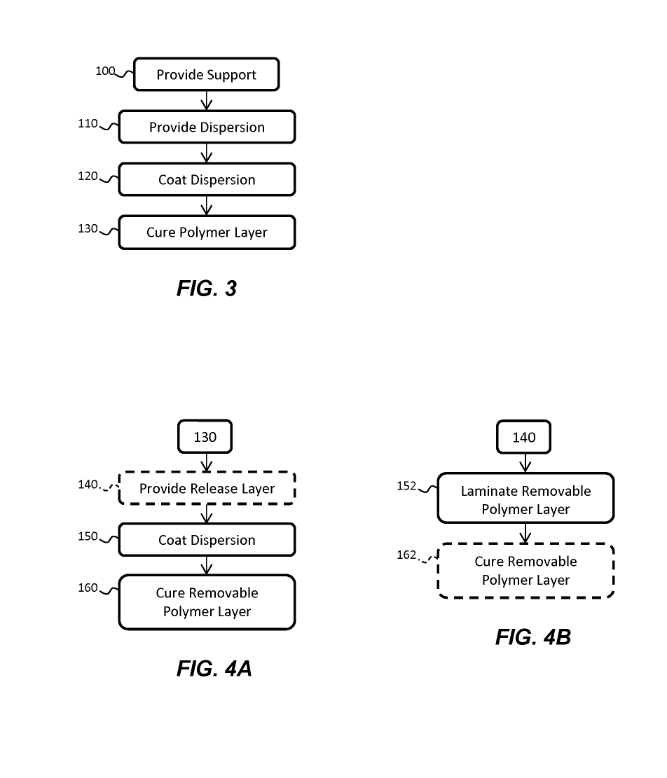

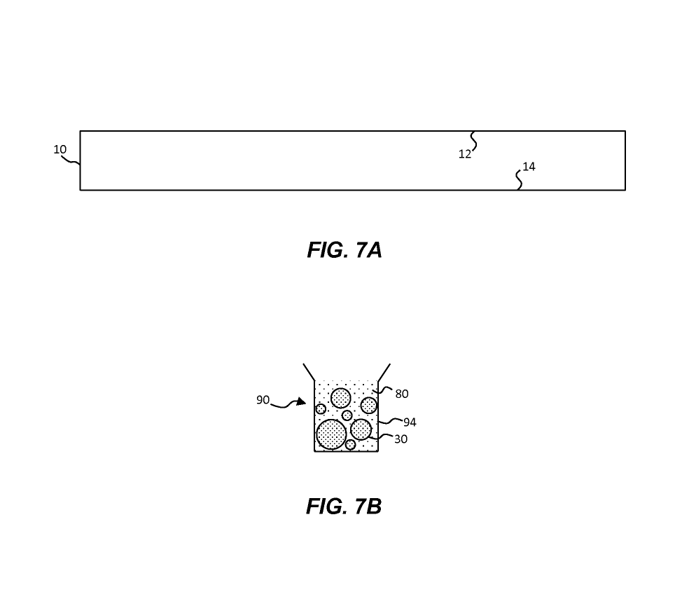

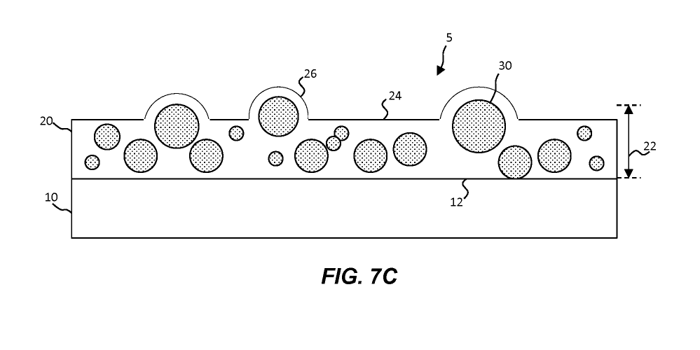

Referring next to the flow chart of FIG. 3 and the sequential cross sections of FIGS. 7A-7C, a method of making the biocidal article 5 includes providing the support 10 having the first side 12 and the opposing second side 14 in step 100 as shown in FIG. 7A. A dispersion 90 is formed with a liquid polymer 80, for example a curable resin, in a container 94 in step 110 and as shown in FIG. 7B. The dispersion 90 includes biocidal particles 30 in the liquid polymer 80. The biocidal particles 30 include a metal salt having soluble constituents and a median particle diameter 32 less than or equal to two microns. In step 120 the dispersion 90 is coated on the first side 12 of the support 10 to form the polymer layer 20 adhered to the first side 12 of the support 10 (FIG. 7C). The polymer layer 20 has an average layer thickness 22 and the top surface 24.

Making and coating liquids with dispersed particles is known in the art. Coating methods, for example, can include spin coating, hopper coating, or curtain coating. A dispersion having antimicrobial biocidal particles 30 has been made. The dispersion included three-micron silver sulfate particles milled in an SU8 liquid to an average particle size of one micron, and successfully coated on glass.

The polymer layer 20 is cured in step 130 to fix the biocidal particles 30 with the coating 26 in the polymer layer 20. The curing step 130 can cross-link the polymer 80 in the polymer layer 20. The biocidal particles 30 are coated by the polymer 80. The average layer thickness 22 is less than or equal to two times the median particle diameter 32. At least some of the plurality of biocidal particles 30 extend beyond the average layer thickness 22 from the support 10 and the polymer 80 forms a semi-permeable membrane through which the soluble constituents percolate to the top surface 24. In various embodiments of the present invention, curing the polymer layer 20 includes drying the polymer layer 20, heating the polymer layer 20, or exposing the polymer layer 20 to electromagnetic radiation such as ultra-violet radiation. Alternatively, the dispersion 90 further includes a surfactant and curing the polymer layer 20 includes removing the surfactant.

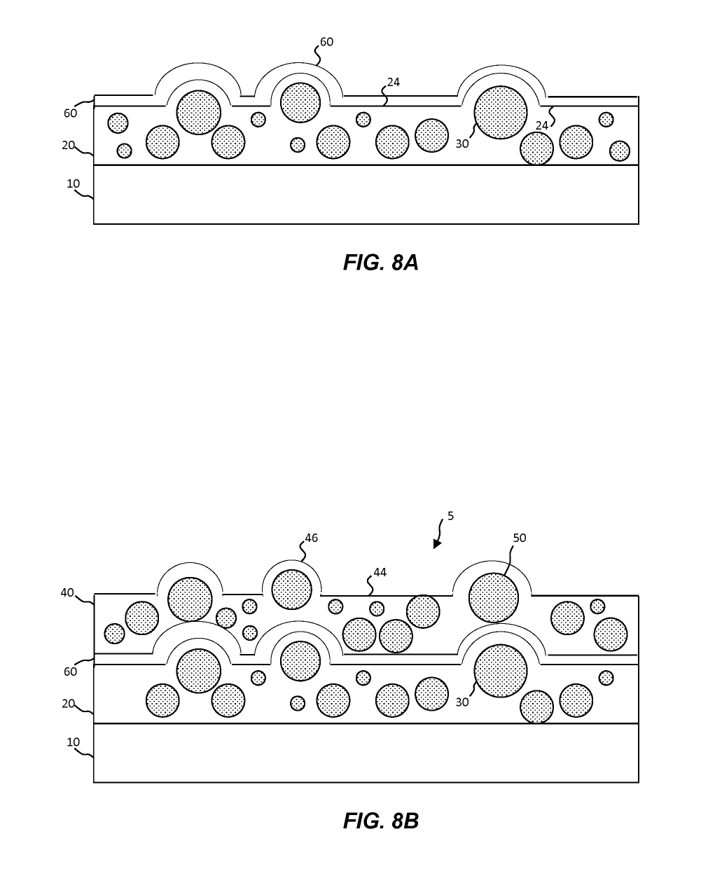

Referring to FIG. 4A, in a further embodiment of the present invention, in optional step 140 the release layer 60 is provided, for example by coating or laminating a removable adhesive on the top surface 24 of the polymer layer 20 on support 10 as illustrated in FIG. 8A. In step 150, the dispersion 90 is coated on the polymer layer 20 to form a removable polymer layer 40 adhered to the polymer layer 20 or a layer on the polymer layer 20 (e.g. release layer 60, as shown). The removable polymer layer 40 has another average layer thickness 42 and other top surface 44. If the release layer 60 is provided (step 140) as shown in FIG. 8B, the dispersion 90 is coated on the release layer 60 to form the removable polymer layer 40 adhered to the release layer 60. If the release layer 60 is not provided the removable polymer layer 40 is adhered to the polymer layer 20 or other layers formed on the polymer layer 20. The removable polymer layer 40 is cured in step 160 to fix other biocidal particles 50 within the removable polymer layer 40, the other biocidal particles 50 coated by the removable polymer layer 40 with an other coating 46. The curing step 160 can cross-link the other polymer 82 in the removable polymer layer 40. The other average layer thickness 42 is less than or equal to two times the other median particle diameter 52, at least some of the other biocidal particles 50 extend beyond the other average layer thickness 42 from the polymer layer 20, and the removable polymer layer 40 forms a semi-permeable membrane through which the soluble constituents percolate to the other top surface 44.

In an alternative method, as illustrated in FIG. 4B, the removable polymer layer 40 is laminated to the polymer layer 20 or to a layer affixed to the polymer layer 20 on a side of the polymer layer 20 opposite the support 10 in step 152, the removable polymer layer 40 including the other polymer 82 and having another average layer thickness 42, other top surface 44, and the other biocidal particles 50 fixed within the removable polymer layer 40, the other biocidal particles 50 coated by the other polymer 82. In an embodiment, the layer affixed to the polymer layer 20 on a side of the polymer layer 20 opposite the support 10 is the release layer 60 or the support 10.

For example, in a further useful embodiment, and as illustrated in FIG. 9, the removable polymer layer 40 is laminated or otherwise affixed to a separate other support 11 or to the optional release layer 60. The separate other support 11 is thus located between the polymer layer 20 and the removable polymer layer 40. In an embodiment, such a structure is made by first making the biocidal article 5 of FIG. 1, cutting the biocidal article 5 into two or more separate portions, and then laminating one portion (which then becomes the removable polymer layer 40) onto the polymer layer 20, with an optional release layer 60 between the polymer layer 20 and the removable polymer layer 40. Alternatively, two separate biocidal articles 5 can be laminated together.

The other average layer thickness 42 is less than or equal to two times the other median particle diameter 52, at least some of the other biocidal particles extend beyond the other average layer thickness 42 from the polymer layer 20, and the other polymer 82 forms a semi-permeable membrane through which the soluble constituents percolate to the other top surface 44. In different embodiments, the laminated removable polymer layer 40 is supplied in an uncured state, a partially cured state, or a cured state. If the removable polymer layer 40 is not cured, in optional step 162 the removable polymer layer 40 is cured, for example by heating, drying, or exposure to electromagnetic radiation.

Methods of lamination, including methods of laminating with release layers, forming dispersions including polymers and particles, and dispersion coating suitable for methods and articles of the present invention are known in the art.

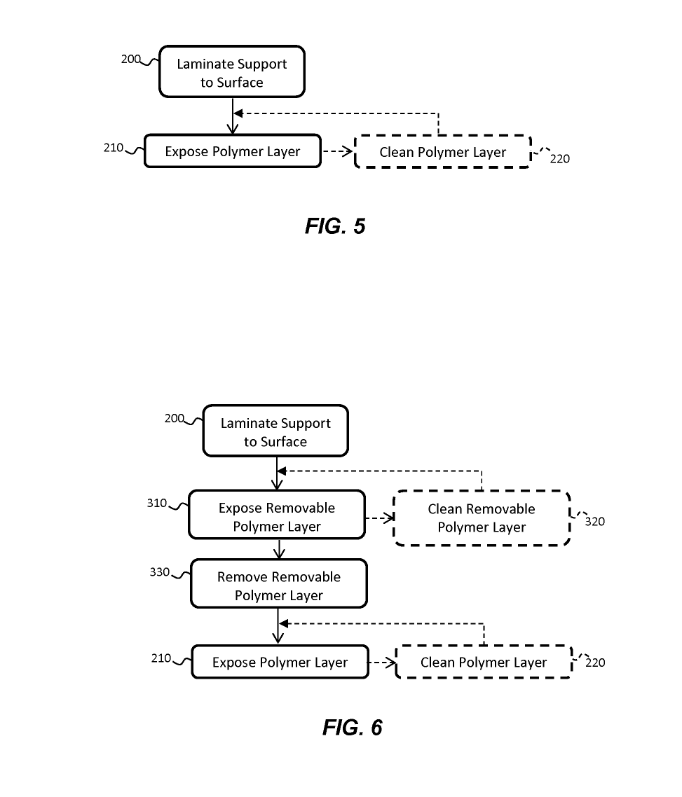

Referring to FIG. 5, a method of using the biocidal article 5 includes providing the biocidal article 5 and, in step 200, adhering the second side 14 of the support 10 to the surface 70, for example with an adhesive and by lamination. The polymer layer 20 is exposed to the environment in step 210, for example an environment rife with undesirable biological organisms 92 such as bacteria, and particularly drug-resistant bacteria, as illustrated in FIG. 10. According to the present invention, the biocidal article 5 kills or otherwise inhibits the life and reproduction of the undesirable biological organisms 92 on the top surface 24 of the biocidal article 5 polymer layer 20. The silver sulfate particle dispersion 90 noted above was spin-coated on the glass support 10, cured, and tested for anti-microbial efficacy.

After a random or pre-determined period of time, in optional step 220 the top surface 24 of the polymer layer 20 is cleaned, for example with liquids, cleansers, detergents, liquid cleaning agents, or other cleaners. According to the present invention, the biocidal properties of the polymer layer 20 are maintained after cleaning (step 220) as the soluble constituents of the biocidal particles 30 percolate to the top surface 24 since the coating 26 protects the biocidal particles 30 from dissolution. Thus, in an embodiment, the polymer layer 20 is repeatedly exposed to the environment (step 210) after cleaning (step 220). In an experiment, the spin-coated dispersion 90 noted above was subjected to cleaning steps 220 and further leaching of biocidal materials into the environment (step 220) from the biocidal particles 30 through the coating 26 after the cleaning (step 210) was observed.

In an embodiment, the cleaning step 210 removes dead micro-organisms or dirt from the top surface 24 of the polymer layer 20 so that the biocidal efficacy of the biocidal particles 30 is improved in the absence of the dead micro-organisms or dirt. Useful cleaners include hydrogen peroxide, for example 2% hydrogen peroxide, water, soap in water, or a citrus-based cleaner. In an embodiment, the 2% hydrogen peroxide solution is reactive to make oxygen radicals that improve the efficacy of biocidal particles 30. In various embodiments, cleaning is accomplished by spraying the top surface 24 of the polymer layer 20 with a cleaner and then wiping or rubbing the top surface 24. In some embodiments, the cleaner can dissolve a portion of the polymer layer 20 material and the wiping or rubbing can remove dissolved material or abrade the top surface 24.

Referring to FIG. 6, another method of using a biocidal article 5 includes providing the biocidal article 5 and, in step 200, adhering the second side 14 of the support 10 to the surface 70, for example with an adhesive and by lamination. The removable polymer layer 40 is exposed to the environment in step 310, for example an environment rife with undesirable biological organisms 92 such as bacteria, and particularly drug-resistant bacteria. After a random or pre-determined period of time, in optional step 320 the other top surface 44 of the removable polymer layer 40 is optionally cleaned, for example with liquids, cleansers, detergents, liquid cleaning agents, or other cleaners. According to the present invention, the biocidal properties of the removable polymer layer 40 are maintained after cleaning as the soluble constituents of the biocidal particles 50 percolate to the other top surface 44 since the other coating 46 protects the biocidal particles 50 from dissolution. Thus, in an embodiment, the removable polymer layer 40 is repeatedly exposed to the environment after cleaning.

After one or more cleaning steps 320 and exposures 310 to the environment, the removable polymer layer 40 is removed in step 330, for example by mechanically separating the removable polymer layer 40 from the polymer layer 20, with or without the use of the release layer 60. The polymer layer 20 is then repeatedly exposed to the environment in step 210 and optionally repeatedly cleaned in step 220. Mechanical separation methods and equipment, for example manual peeling, are known in the art.

According to embodiments of the present invention, the biocidal particles 30 or other biocidal particles 50 include silver sulfate. Silver sulfate used in this invention can be prepared by a number of methods as disclosed in U.S. Pat. No. 7,261,867, U.S. Pat. No. 7,655,212, U.S. Pat. No. 7,931,880, and U.S. Patent Application Publication 20090258218. Included in these methods is silver sulfate prepared in aqueous solution by adding together a soluble silver salt and a soluble inorganic sulfate together under turbulent mixing conditions in a precipitation reactor. An additional method to prepare silver sulfate includes precipitation in nonaqueous solutions. Still further methods to prepare silver sulfate include solid-state reaction, thermal processing, sputtering, and electrochemical processing. Additives can be included during the preparation process including size control agents, color control agents, antioxidants, and the like. Silver sulfate in this invention can be used as made or milled or ground to a smaller particle size. Determination of particle size is carried out using grain size measurements provided for by instance an LA-920 analyzer from Horiba Instruments, Inc. The silver sulfate particle size is in a range of greater than zero but less than or equal to 2 microns.

In the present invention, the polymer layer 20 or the releasable polymer layer 40 includes a plastic resin or polymer agent. These polymer agents include those derived from vinyl monomers, such as styrene monomers, or condensation monomers such as esters and mixtures thereof. These polymer agents include homopolymers and copolymers such as polyesters, styrenes, e.g. styrene or chlorostyrene; monoolefins, e.g. ethylene, propylene, butylene or isoprene; vinyl esters, e.g. vinyl acetate, vinyl propionate, vinyl benzoate or vinyl butyrate; α-methylene aliphatic monocarboxylic acid esters, e.g. methyl acrylate, ethyl acrylate, butyl acrylate, dodecyl acrylate, octyl acrylate, phenyl acrylate, methyl methacrylate, ethyl methacrylate, butyl methacrylate or dodecyl methacrylate; vinyl ethers, e.g. vinyl methyl ether, vinyl ethyl ether and vinyl butyl ether; or vinyl ketones, e.g. vinyl methyl ketone, vinyl hexyl ketone and vinyl isopropenyl ketone. Particularly desirable binder polymers/resins include polystyrene resin, polyester resin, styrene/alkyl acrylate copolymers, styrene/alkyl methacrylate copolymers, styrene/acrylonitrile copolymer, styrene/butadiene copolymer, styrene/maleic anhydride copolymer, polyethylene resin or polypropylene resin.

The polymer agents further include polyurethane resin, epoxy resin, silicone resin, polyamide resin, modified rosin, paraffins or waxes, carboxymethyl cellulose (CMC), gelatin, alkali-treated gelatin, acid treated gelatin, gelatin derivatives, proteins, protein derivatives, synthetic polymeric binders, water soluble microgels, polystyrene sulphonate, poly(2-acrylamido-2-methylpropanesulfonate) or polyphosphates. Especially useful are polyesters of aromatic or aliphatic dicarboxylic acids with one or more aliphatic diols, such as polyesters of isophthalic or terephthalic or fumaric acid with diols such as ethylene glycol, cyclohexane dimethanol or bisphenol adducts of ethylene or propylene oxides.

Preferably the acid values (expressed as milligrams of potassium hydroxide per gram of resin) of the polyester resins are in the range of 2-100. The polyesters can be saturated or unsaturated. Of these resins, styrene/acryl and polyester resins are particularly effective. Resins having a viscosity in the range of 1 to 100 centipoise when measured as a 20 weight percent solution in ethyl acetate at 25° C. are useful in some embodiments.

Colorants, a pigment or dye, suitable for use in the practice of the present invention are disclosed, for example, in U.S. Reissue Pat. No. 31,072 and in U.S. Pat. Nos. 4,160,644; 4,416,965; 4,414,152 and 2,229,513. Colorants be red, green, blue, black, magenta, cyan, yellow, and any combination of these colorants and include, for example, carbon black, Aniline Blue, Calcoil Blue, Chrome Yellow, Ultramarine Blue, SunBright Blue 61, Du Pont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 97, C.I. Pigment Yellow 12, C.I. Pigment Yellow 17, C.I. Pigment Blue 15:1 or C.I. Pigment Blue 15:3. Colorants can generally be employed in the range of from 1 to 90 weight percent on a total powder weight basis, and preferably in the range of 2 to 20 weight percent, and most preferably from 4 to 15 weight percent in the practice of this invention. When the colorant content is 4% or more by weight, a sufficient coloring power can be obtained, and when it is 15% or less by weight, good transparency can be obtained. Mixtures of colorants can also be used. Colorants in any form such as dry powder, its aqueous or oil dispersions, wet cake, or masterbatches can be used in the present invention. Colorant milled by any methods like media-mill or ball-mill can be used as well. The colorant can be incorporated in the oil phase or in the first aqueous phase in the ELC process.

The release agents used in the release layers 60 can include waxes. Concretely, the releasing agents usable herein are low-molecular weight polyolefins such as polyethylene, polypropylene or polybutylene; silicone resins which can be softened by heating; fatty acid amides such as oleamide, erucamide, ricinoleamide or stearamide; vegetable waxes such as carnauba wax, rice wax, candelilla wax, Japan wax or jojoba oil; animal waxes such as bees wax; mineral or petroleum waxes such as montan wax, ozocerite, ceresine, paraffin wax, microcrystalline wax or Fischer-Tropsch wax; or modified products thereof. Waxes can contain a wax ester having a high polarity, such as carnauba wax or candelilla wax or having a low polarity such as polyethylene wax or paraffin wax. Oils can also be used as release agents. Waxes having a melting point in the range of 30 to 150° C. are preferred and those having a melting point in the range of 40 to 140° C. are more preferred. The wax concentration is, for example, 0.1 to 20 weight % and preferably 0.5 to 8 weight %.

One method for making the initial dispersion is to melt polymer 80 in a glass, metal or other suitable vessel (e.g., container 94), followed by any other desired additives, for example a surfactant or cross-linking material. The polymer 80 and additives are mixed using a spatula until the additives are properly dispersed in the polymer 80, followed by the addition of the biocidal particles 30, for example silver sulfate. The biocidal particles 30 are mixed using a spatula until it is appropriately dispersed in the polymer 80. Another method for making the composite is to melt the polymer 80 in a small compounder, such as a Brabender compounder, followed by addition of the additives, compound until the additives are properly dispersed in the polymer 80, followed by addition of the biocidal particles 30, for example silver sulfate, until the biocidal particles 30 are appropriately dispersed in the polymer 80. Yet in another method such as in the case of a single or twin-screw compounder, these compounders are provided with main feeders through which polymer pellets or powders are fed. Additives can be mixed with and fed simultaneously with the polymer pellets or powders. Additives can also be fed using a feeder located downline from the polymer feeder. Both procedures will produce an initial composition. The biocidal particles 30 are then fed using a top feeder or using a side stuffer. If the side stuffer is used to feed the biocidal particles 30 then the feeder screw design needs to be appropriately configured. The preferred mode of addition of the biocidal particles 30 to the polymer 80 is by the use of a side stuffer, although a top feeder can be used, to ensure proper viscous mixing and to ensure dispersion of the biocidal particles 30 through the initial composition polymer matrix as well as to control the thermal history.

Alternatively, the initial composition containing the additives of the invention can be compounded and collected, then fed through the main feeder before addition of the biocidal particles 30. In one embodiment, the biocidal particles 30 can be pre-dispersed along with the polymer 80 and additives of the invention in the initial composition using a mixing apparatus such as a Henschel Mixer and compounded using the methods described. The resulting composite material obtained after compounding can be further processed into pellets, granules, strands, ribbons, fibers, powder, films, plaques, foams and the like for subsequent use.

A master batch of the biocidal particles 30 in polymer agent and any additives can be further diluted by compounding the master batch with polymer agent and additives of the invention, resulting in a biocidal particle concentration of 5 weight % to 15 weight % biocidal particles 30. The extruded composite including polymer agent, additives, and the biocidal particles 30 are then mechanically ground in a way known to anyone skilled in the art. The biocidal particle 30 concentration is analyzed using Inductively Coupled Plasma (ICP) or X-ray Fluorescence (XRF) to measure, for example elemental silver, and X-ray Diffraction (XRD) to confirm the biocidal particles 30 are present. ICP measurements were carried out using a Perkin Elmer Optima 2000 ICP optical emission spectrometer, XRF measurements were carried out using a Bruker S8 wavelength dispersive XRF spectrometer, XRD measurements were carried out using a Rigaku D2000 diffractometer.

An experimental and inventive embodiment of the present invention was made by coating a dispersion on a glass substrate (e.g., support 10). The dispersion included three-micron silver sulfate particles (e.g., the biocidal particles 30) milled in an SU8 liquid to an average particle size of one micron. The dispersion was coated on glass at concentrations by weight of 5 weight %, 10 weight %, and 15 weight % biocidal particles 30. Each of the coatings was successfully tested with E. coli bacteria, for example the 5% coating demonstrating a two-order-magnitude reduction in the presence of E. Coli. The coatings were then subjected to leach tests by water immersion (simulating the effect of washing) for various periods of time ranging up to one week. The water bath was then tested for the presence of silver. The tests demonstrated repeated leaching of silver over the tested periods. Separately prepared samples were then exposed to a mechanical cleaning step using a small wet (with water) cotton swab repeatedly applied over the surface of the samples. Repeated leaching tests performed after multiple mechanical cleaning steps then demonstrated the on-going presence of silver.

The biocidal article 5 of the present invention provides advantages over the prior art in longevity and efficacy and enables cleaning of the top surface 24 of the polymer layer 20. Experiments have demonstrated that prior-art structures with exposed biocidal particles 30 (for example as taught in U.S. Patent Application Publication 2010/0034900), although biocidally efficacious are not robust when cleaned, for example by mechanical or liquid cleaning, or both. Such cleaning steps are commonplace and necessary in the presence of spills or other environmental contaminants that undesirably come into contact with the biocidal article 5. Experiments have demonstrated that exposed biocidal particles can lose more than a factor of ten in biocidal efficacy each time when exposed to water or mechanically cleaned.

In contrast, the coating 26 of the biocidal article 5 of the present invention protects the biocidal particles 30, especially from mechanical abrasion but also from fluids, while also better maintaining biocidal efficacy. At the same time the surface area of the preferred size of the biocidal particles 30 enables sufficient biocidal efficacy. By constraining the relative polymer layer 20 depth, (i.e., the average layer thickness 22) the thickness of the coating 26 of the biocidal particles 30 is reduced, thereby enabling the projection of the biocidal particles 30 above the average layer thickness 22 and providing a thinner coating (i.e., coating 26) that enables sufficient biocidal efficacy while enabling cleaning without biocidal efficacy loss. In contrast, larger particles of the prior art might reduce efficacy by reducing surface area and smaller particles of the prior art might increase coating thickness, both reducing biocidal efficacy. A relatively thicker polymer layer 20 might likewise reduce biocidal efficacy. The combination of the median particle diameter 32 of the biocidal particles 30 and relative polymer average layer thickness 22 unexpectedly increases efficacy while enabling cleaning.

The present invention provides a coating that is inhospitable to bacteria over a period of time, can be readily replaced with minimal effort, and that can be cleaned.

The invention has been described in detail with particular reference to certain preferred embodiments thereof, but it will be understood that variations and modifications can be effected within the spirit and scope of the invention.

### PARTS LIST

5 biocidal article
10 support
11 other support
12 first side
13 other first side
14 second side
15 other second side
20 polymer layer
22 average layer thickness
24 top surface of polymer layer
26 coating
30 biocidal particle
32 median particle diameter
40 removable polymer layer
42 other average layer thickness
44 other top surface
46 other coating
50 other biocidal particle
52 other median particle diameter
60 release layer
70 surface
80 polymer
82 other polymer
90 dispersion
92 biological organisms
94 container
100 provide support step
110 provide dispersion step
120 coat dispersion step
130 cure polymer layer step

### PARTS LIST CONT'D

140 optional provide release layer step
150 coat dispersion step
152 laminate removable polymer layer step
160 cure removable polymer layer step
162 optional cure removable polymer layer step
200 laminate support to surface step
210 expose polymer layer step
220 optional clean polymer layer step
310 expose removable polymer layer step
320 optional clean removable polymer layer step
330 remove removable polymer layer step

1. A biocidal article, comprising:
a support having a first side and an opposing second side;
a polymer layer including a polymer adhered to the first side of the support, the polymer layer having an average layer thickness and a top surface;
a plurality of biocidal particles fixed within the polymer layer, the biocidal particles coated by the polymer, the biocidal particles having a median particle diameter less than or equal to two microns, and the biocidal particles including a metal salt having soluble constituents; and
wherein the average layer thickness is less than or equal to two times the median particle diameter, at least some of the biocidal particles extend beyond the average layer thickness from the support, and the polymer forms a semi-permeable membrane through which the soluble constituents percolate to the top surface.

2. The biocidal article of claim 1, wherein the metal salt is a silver salt, silver sulfate, a copper salt, or a copper sulfate or includes silver nitrate, silver chloride, silver bromide, silver iodide, silver iodate, silver bromate, silver tungstate, or silver phosphate.

3. The biocidal article of claim 1 wherein the metal salt concentration in the polymer layer is greater than or equal to 0.0007 and less than or equal to 5 weight %.

4. The biocidal article of claim 1 wherein the metal salt concentration in the polymer layer is greater than or equal 0.001 and less than or equal to 1 weight %.

5. The biocidal article of claim 1 wherein the metal salt is water soluble.

6. The biocidal article of claim 1 wherein the polymer is a cured resin.

7. The biocidal article of claim 1, wherein the polymer is transparent.

8. The biocidal article of claim 1, wherein the polymer is colored.

9. The biocidal article of claim 1, wherein the polymer interacts with the biocidal particles to color the polymer layer.

10. The biocidal article of claim 1, wherein the polymer layer includes a surfactant.

11. The biocidal article of claim 1 wherein the polymer includes homopolymers and copolymers.

12. The biocidal article of claim 11 wherein the homopolymers and copolymers includes: polyesters, styrenes, monoolefins, vinyl esters, α-methylene aliphatic monocarboxcylic acid esters, vinyl ethers, or vinyl ketones.

13. The biocidal article of claim 1 wherein the polymer further includes: polyurethane resin, epoxy resin, silicone resin, polyamide resin, modified rosin, paraffins or waxes, carboxymethyl cellulose (CMC), gelatin, alkali-treated gelatin, acid treated gelatin, gelatin derivatives, proteins, protein derivatives, synthetic polymeric binders, water soluble microgels, polystyrene sulphonate, poly(2-acrylamido-2-methylpropanesulfonate), polyphosphates, polyesters of aromatic or aliphatic dicarboxcylic acids with one or more aliphatic diols.

14. The biocidal article of claim 1, further including a surface and wherein the surface is adhered to the second side of the support.

15. The biocidal article of claim 1, further including:
a removable polymer layer including another polymer removably adhered to the polymer layer or adhered to a layer affixed to the polymer layer on a side of the polymer layer opposite the support, the removable polymer layer having another average layer thickness and another top surface;
a plurality of other biocidal particles fixed within the removable polymer layer, the other biocidal particles coated by the other polymer, the other biocidal particles having another median particle diameter less than or equal to two microns, and the other biocidal particles including a metal salt having other soluble constituents; and
wherein the average layer thickness of the removable polymer layer is less than or equal to two times the median particle diameter of the other biocidal particles, at least some of the other biocidal particles extend beyond the average layer thickness of the other polymer layer from the first polymer layer or a layer affixed to the polymer layer on a side of the polymer layer opposite the support, and the other polymer forms a semi-permeable membrane through which the other soluble constituents percolate to the other top surface.

16. A method of making a biocidal article, including:
providing a support having a first side and an opposing second side;
providing a dispersion including biocidal particles in a polymer, the biocidal particles including a metal salt having soluble constituents and a median particle diameter less than or equal to two microns;
coating the dispersion on the first side of the support to form a polymer layer adhered to the first side of the support, the polymer layer having an average layer thickness and a top surface;
curing the polymer layer to fix the biocidal particles within the polymer layer, the biocidal particles coated by the polymer; and
wherein the average layer thickness is less than or equal to two times the median particle diameter, at least some of the plurality of biocidal particles extend beyond the average layer thickness from the support, and the polymer forms a semi-permeable membrane through which the soluble constituents percolate to the top surface.

17. The method of claim 16, wherein curing includes drying the polymer layer or heating the polymer layer.

18. The method of claim 16, wherein the dispersion further includes a surfactant and wherein curing includes removing the surfactant.

19. The method of claim 16, further including:
coating the dispersion on the polymer layer to form a removable polymer layer adhered to the polymer layer, the removable polymer layer having another average layer thickness and another top surface, the removable polymer layer including another polymer and other biocidal particles;
curing the removable polymer layer to fix the other biocidal particles within the removable polymer layer, the other biocidal particles coated by the other polymer; and
wherein the other average layer thickness is less than or equal to two times the other median particle diameter, at least some of the additional biocidal particles extend beyond the other average layer thickness from the polymer layer, and the other polymer forms a semi-permeable membrane through which the soluble constituents percolate to the other top surface.

20. The method of claim 19, further including providing a release layer between the polymer layer and the removable polymer layer.

21. The method of claim 15, further including:
laminating a removable polymer layer to the polymer layer or to a layer affixed to the polymer layer on a side of the polymer layer opposite the support, the removable polymer layer including another polymer and having another average layer thickness, another top surface, and other biocidal particles fixed within the removable polymer layer, the other biocidal particles coated by the other polymer; and
wherein the other average layer thickness is less than or equal to two times the median particle diameter, at least some of the other biocidal particles extend beyond the other average layer thickness from the polymer layer or from a layer affixed to the polymer layer on a side of the polymer layer opposite the support, and the other polymer forms a semi-permeable membrane through which the soluble constituents percolate to the other top surface.

22. A method of using a biocidal article, including:
providing the biocidal article of claim 1; and
adhering the second side of the support to a surface.

23. The method of claim 22, further including cleaning the top surface of the polymer layer.

24. A method of using a biocidal article, including:
providing the biocidal article of claim 15;
adhering the second side of the support to a surface;
exposing the other top surface to an environment;
optionally cleaning the other top surface; and
removing the removable polymer layer from the polymer layer.

25. The method of claim 24, further including cleaning the top surface of the polymer layer.
